(19) United States
(12) Patent Application Publication
(10) Pub. No.: US 2012/0178402 A1
(43) Pub. Date: Jul. 12, 2012

(54) Optimized Limited Service Acquisition in a Multiple Subscription Device

(76) Inventors: Sathish Krishnamoorthy, Hyderabad (IN); Ajit Gupta, Hyderabad (IN); Uttam Pattanayak, Hyderabad (IN); Shivank Nayak, Hyderabad (IN); Suresh Sanka, Hyderabad (IN); Asimava Bera, Balanagar Mandal (IN)

(21) Appl. No.: 12/987,744

(22) Filed: Jan. 10, 2011

(51) Int. Cl. H04W 88/06; H04W 4/22

(52) U.S. Cl. 455/404.1

(57) ABSTRACT

Mobile devices, such as a dual standby global phone, can have multiple subscriptions to access different radio access technologies, such as Global System for Mobile Communications (GSM) and Code Division Multiple Access (CDMA) technologies. A selective scanning utility recognizes that emergency calls can be processed in any active subscription rather than being independently invoked to obtain a plurality of ways to make an emergency call. The utility limits service acquisition to just one of all active subscriptions in device, thereby achieving the objective of staying camped for limited service without needing to perform cell selection on emergency call origination on a secondary subscription at the cost of battery service. For single-radio devices, this solution also increases the availability of the first selected cell by avoiding the need to tune away for cell selection on the secondary subscription.

### BACKGROUND

1. Field

The present disclosure relates to a mobile operating environment, and more particularly, to maintaining access for an emergency call by user equipment provisioned to access different radio access technologies using multiple subscriptions.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Universal Mobile Telecommunications System (UMTS) is one of the third-generation (3G) cell phone technologies. UTRAN, short for UMTS Terrestrial Radio Access Network, is a collective term for the Node-B's and Radio Network Controllers which make up the UMTS radio access network. This communications network can carry many traffic types from real-time Circuit Switched to IP based Packet Switched. The UTRAN allows connectivity between the UE (user equipment) and the core network. The RNC provides control functionalities for one or more Node Bs. A Node B and an RNC can be the same device, although typical implementations have a separate RNC located in a central office serving multiple Node B's. Despite the fact that they do not have to be physically separated, there is a logical interface between them known as the Iub. The RNC and its corresponding Node Bs are called the Radio Network Subsystem (RNS). There can be more than one RNS present in an UTRAN.

CDMA2000 (also known as IMT Multi Carrier (IMT MC)) is a family of 3G mobile technology standards, which use CDMA channel access, to send voice, data, and signaling data between mobile phones and cell sites. The set of standards includes: CDMA2000 1X, CDMA2000 EV-DO Rev. 0, CDMA2000 EV-DO Rev. A, and CDMA2000 EV-DO Rev. B. All are approved radio interfaces for the ITU's IMT-2000. CDMA2000 has a relatively long technical history and is backward-compatible with its previous 2G iteration IS-95 (cdmaOne).

CDMA2000 1X (IS-2000), also known as 1x and 1xRTT, is the core CDMA2000 wireless air interface standard. The designation “1x”, meaning 1 times Radio Transmission Technology, indicates the same RF bandwidth as IS-95: a duplex pair of 1.25 MHz radio channels. 1xRTT almost doubles the capacity of IS-95 by adding 64 more traffic channels to the forward link, orthogonal to (in quadrature with) the original set of 64. The 1X standard supports packet data speeds of up to 153 kbps with real world data transmission averaging 60-100 kbps in most commercial applications. IMT-2000 also made changes to the data link layer for the greater use of data services, including medium and link access control protocols and Quality of Service (QoS). The IS-95 data link layer only provided “best effort delivery” for data and circuit switched channel for voice (i.e., a voice frame once every 20 ms).

CDMA2000 1xEV-DO (Evolution-Data Optimized), often abbreviated as EV-DO or EV, is a telecommunications standard for the wireless transmission of data through radio signals, typically for broadband Internet access. It uses multiplexing techniques including code division multiple access (CDMA) as well as time division multiple access (TDMA) to maximize both individual user's throughput and the overall system throughput. It is standardized by 3rd Generation Partnership Project 2 (3GPP2) as part of the CDMA2000 family of standards and has been adopted by many mobile phone service providers around the world, particularly those previously employing CDMA networks.

3GPP LTE (Long Term Evolution) is the name given to a project within the 3rd Generation Partnership Project (3GPP) to improve the UMTS mobile phone standard to cope with future requirements. Goals include improving efficiency, lowering costs, improving services, making use of new spectrum opportunities, and better integration with other open standards. The LTE system is described in the Evolved UTRA (EUTRA) and Evolved UTRAN (EUTRAN) series of specifications.

In addition to voice services, mobile devices are increasingly being used for data packet services such as Internet Protocol (IP) web browsing, and data burst messages such as Short Message Service (SMS) text messaging and Media Message Service (MMS) messaging, etc. Further, Location Based Services (LBS) are a popular feature provided by many wireless mobile devices for navigation utilities, social networking based on geography, directory information for local goods and services, etc. Often, such LBS applications can share an existing data connection to maintain such guidance without interfering with other data packet services.

One way in which multiple data packet services are managed is by provisioning a mobile device with subscriber identification. In order for handsets to interface with subscriber networks, subscriber identification carried by the handset is required. For example, a Subscriber Identity Module (SIM) on a removable SIM card securely stores the service-subscriber key for identification purposes on mobile telephony devices (such as mobile phones and computers). The SIM card allows users to change phones by simply removing the SIM card from one mobile phone and inserting it into another mobile phone or broadband telephony device.

A SIM card contains its unique serial number, International Mobile Subscriber Identifier (IMSI) of the mobile device, security authentication and ciphering information, temporary information related to the local network, a list of the services the user has access to and two passwords (Personal Identification Number (PIN) for usual use and Personal Unblocking Key (PUK) for unlocking).

Each SIM card stores a unique International Mobile Subscriber Identity (IMSI), of this number format: (a) The first 3 digits represent the Mobile Country Code (MCC); (b) The next two or three digits represent the Mobile Network Code (MNC); (c) The remaining digits represent the Mobile Station Identification (MSID) number; and (d) A SIM card also has an Integrated Circuit Card Identification (ICC-ID) number.

A virtual SIM is a mobile phone number provided by a mobile network operator that does not require a SIM card to terminate phone calls on a user's mobile phone.

A RUIM card (also R-UIM) or Removable User Identification Module, is a removable smart card for cellular phones made for the CDMA2000 network. The R-UIM is essentially the 3GPP/ETSI SIM for CDMA2000 systems—which are both based on the Integrated Circuit Card (ICC). The RUIM card holds a user's personal information such as name and account number, cell phone number, phone book, text messages and other settings.

A CDMA2000 Subscriber Identify Module (CSIM) is an application that runs on the newer smart card known as the Universal Integrated Circuit Card (UICC). The UICC can store a CSIM application, USIM application, SIM and/or R-UIM and can be used to enable operation with cellular networks globally. UICC carries the Application Directory Files (ADF) of CSIM and USIM and others. SIM and R-UIM are legacy cards based on ICC. Both SIM and R-UIM can be added on to the UICC but not as an ADF but as a DF (Directory File). The UICC which can carry a CSIM application allows users to change phones by simply removing the smart card from one mobile phone and inserting it into another mobile phone or broadband telephony device.

Open Market Handsets (OMH) is an initiative led by the CDMA Development Group (CDG). OMH recently has introduced a concept to allow network operators to configure and support different multiple Simple Internet Protocol (SIP)/Mobile Internet Protocol (MIP) profiles to distinguish different kinds of data calls for billing purposes, usage statistics, to satisfy specific data rate, and specific bearer technology requirements. Multiple profiles can also be used to route data traffic differently for different kind of applications. For example, a Wireless Application Protocol (WAP) client can have a need to go through a WAP server, so a local IP Address may be used whereas a tethered data call may need a public IP address. Different profiles can also be used to control different data applications when run simultaneously through application priority control.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method is provided for accessing wireless wide area network communication with multiple subscriptions for an emergency call. On user equipment, a first subscription is accessed for registering on a first radio access technology and a second subscription is accessed for registering on a second radio access technology. A determination is made as to whether the user equipment is camping on the first radio access technology for full or limited service. A determination is made as to whether the user equipment is camping on the second radio access technology for full or limited service. A transceiver scans for at least limited service for the first radio access technology in response to determining that the user equipment is not camping on the second radio access technology. The second radio access technology is used for any emergency call in response to determining that the user equipment is camping on the second radio access technology.

In another aspect, at least one processor is provided for accessing wireless wide area network communication with multiple subscriptions for an emergency call. A first module accesses a first subscription on user equipment for registering on a first radio access technology and a second subscription for registering on a second radio access technology. A second module determines whether the user equipment is camping on the first radio access technology for full or limited service. A third module determines whether the user equipment is camping on the second radio access technology for full or limited service. A fourth module scans via a transceiver for at least limited service for the first radio access technology in response to determining that the user equipment is not camping on the second radio access technology. A fifth module uses the second radio access technology for any emergency call in response to determining that the user equipment is camping on the second radio access technology.

In an additional aspect, a computer program product is provided for accessing wireless wide area network communication with multiple subscriptions for an emergency call. A non-transitory computer-readable medium stores sets of code. A first set of code causes a computer to access on user equipment a first subscription for registering on a first radio access technology and a second subscription for registering on a second radio access technology. A second set of code causes the computer to determine whether the user equipment is camping on the first radio access technology for full or limited service. A third set of code causes the computer to determine whether the user equipment is camping on the second radio access technology for full or limited service. A fourth set of code causes the computer to scan via a transceiver for at least limited service for the first radio access technology in response to determining that the user equipment is not camping on the second radio access technology. A fifth set of code causes the computer to use the second radio access technology for any emergency call in response to determining that the user equipment is camping on the second radio access technology.

In a further aspect, an apparatus is provided for accessing wireless wide area network communication with multiple subscriptions for an emergency call. The apparatus comprises means for accessing on user equipment a first subscription for registering on a first radio access technology and a second subscription for registering on a second radio access technology. The apparatus comprises means for determining whether the user equipment is camping on the first radio access technology for full or limited service. The apparatus comprises means for determining whether the user equipment is camping on the second radio access technology for full or limited service. The apparatus comprises means for scanning via a transceiver for at least limited service for the first radio access technology in response to determining that the user equipment is not camping on the second radio access technology. The apparatus comprises means for using the second radio access technology for any emergency call in response to determining that the user equipment is camping on the second radio access technology.

In yet another aspect, an apparatus is provided for accessing wireless wide area network communication with multiple subscriptions for an emergency call. A computing platform accesses on user equipment a first subscription for registering on a first radio access technology and a second subscription for registering on a second radio access technology. The computing platform is further for determining whether the user equipment is camping on the first radio access technology for full or limited service. In addition, the computing platform is further for determining whether the user equipment is camping on the second radio access technology for full or limited service. A first transceiver scans for at least limited service for the first radio access technology in response to the computing platform determining that the user equipment is not camping on the second radio access technology. The computing platform is further for using the second radio access technology for any emergency call in response to determining that the user equipment is camping on the second radio access technology.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a schematic diagram of a communication system of user equipment using multiple subscriptions to access nodes for an emergency call.

FIG. 2 illustrates a flow diagram of a methodology for accessing wireless wide area network communication with multiple subscriptions for an emergency call.

FIG. 3 illustrates a flow diagram of a methodology that adapts scanning for multiple subscriptions for emergency call connectivity to transceiver and power constraints of the mobile device or user equipment.

FIG. 4 illustrates a flow diagram of a methodology for a state machine for two independently scanning subscriptions.

FIG. 5 illustrates a flow diagram of a methodology for a state machine for enhanced scanning of a subscription.

FIG. 6 illustrates a flow diagram of a methodology for validating implementation of a selective scanning utility.

FIG. 7 illustrates a schematic diagram of an exemplary hard environment for a mobile device having multiple subscriptions.

FIG. 8 illustrates a system of logical groupings of electrical components for selective scanning by multiple subscriptions for emergency calls.

FIG. 9 illustrates a block diagram of a multiple access wireless communication system.

FIG. 10 illustrates a schematic block diagram of an access point and an access terminal of a Multiple Input Multiple Output (MIMO) system.

### DETAILED DESCRIPTION

Consider the following scenario wherein a device has a subscription. The device is camped on a network that has accepted Circuit Switched (CS) and Packet Switched (PS) registration. The device can go out of service from the coverage of this subscription and be unable to find any network that can accept CS or PS registration for this subscription.

The device can go to deep sleep and periodically wake up to look for a suitable cell. If the device finds a cell that provides CS and PS service, the device can stay awake else sleep again. Thereby, longer battery life is attained, although emergency call establishment time can be long in order to perform a cell selection before processing emergency call.

Alternatively, the device can stay awake in order to search for an available cell. Once found, the device can camp on the available cell for limited service. Thereby, battery life is sacrificed in order to reduce emergency call establishment time.

For multiple subscription devices, a natural design objective can be to extend all procedures defined for a single subscription by 3GPP to each of the active subscription in the device. Scaling a 3GPP recommended solution for a multiple subscription device in the above mentioned scenario requires that device camps for limited service on each subscription independently. However, a conventional approach such as this introduces various problems summarized in TABLE 1:

TABLE 1

| Independently | | |
|---|---|---|
| Registered | One of Two Subscriptions | Neither Subscriptions |
| Subscriptions | in Service | in Service |
| Multiple | in-service subscription | increased time of acquisi- |
| Subscription- | will lose pages due to | tion for both the subscrip- |
| One Radio | foreground scan for | tion as both subscriptions |
| | limited service. | are triggering scans. |

| | |
|---|---|
| | Number of limited service scans are too many. Hence, |
| | increased power consumption. |
| Multiple | Number of limited service scans are too many. Hence, |
| Subscriptions- | increased power consumption. |
| Two Radios | |

According to one aspect of the present innovation, it is recognized that emergency calls can be processed in any active subscription. Thus, the multiple subscriptions need not be independently invoked to obtain a plurality of ways to make an emergency call. Instead, the device should attempt limited service acquisition to just one of all active subscriptions in device. This solution will help in achieving the objective of staying camped for limited service without needing to perform cell selection on emergency call origination on a secondary subscription at the cost of battery service. For single-radio devices, this solution also increases the availability of the first selected cell by avoiding the need to tune away for cell selection on the secondary subscription.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

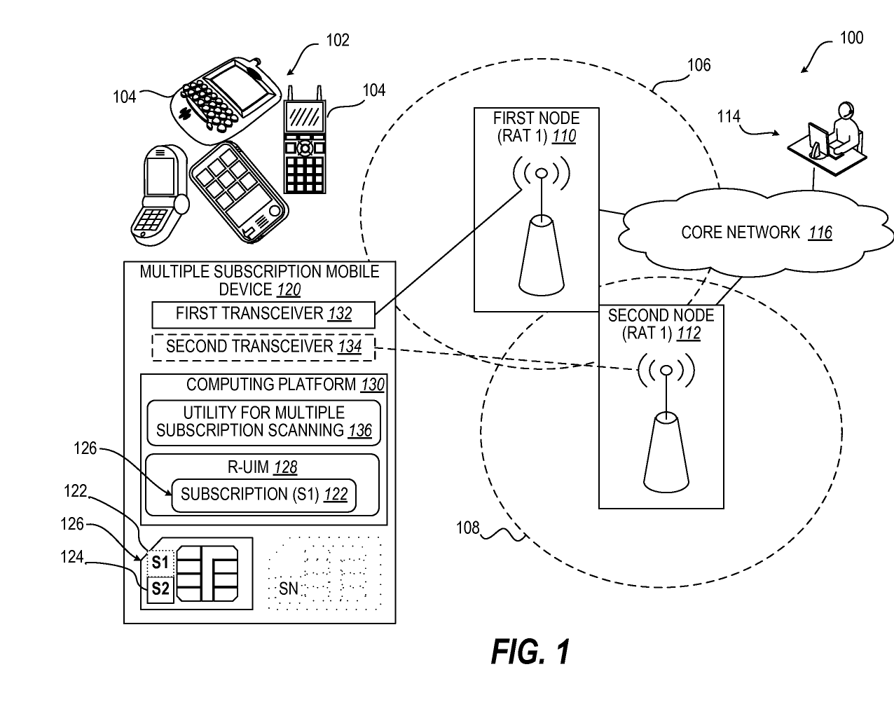

In FIG. 1, in a communication system 100, a population 102 of mobile devices 104 can acquire service from a plurality of Wireless Wide Area Networks (WWANs) 106, 108. The latter are respectively depicted as nodes 110, 112 that serve cells (e.g., macro cells, femtocells) by employing Radio Access Technologies (RATs) according to Global System for Mobile Communications (GSM) and Code Division Multiple Access (CDMA) technologies. In addition to other services, the nodes 110, 112 provide Circuit Switched (CS) or Packet Switched (PS) emergency calling, depicted as a Public Safety Answering Point (PSAP) 114 connected via a Core Network (CN) 116.

In an exemplary aspect, a mobile device 120 of the population 102 of mobile devices 104 can have a dual mode for network compatibility (“multiple subscription”), such as mobile phones containing two types of cellular radios for voice and data. This multiple subscription mobile device 120 is capable of reading multiple subscription data (“S1”, “S2”) 122, 124 and camping on preferred wireless cellular networks (e.g., nodes 110, 112) for each of those subscriptions at the same time. For instance, the mobile device 120 can include a combination of Global System for Mobile Communications (GSM) and Code Division Multiple Access (CDMA) technologies, enabling the mobile device 120 to be used as a GSM or CDMA phone according to user preference.

Alternatively, the subscription data 122, 124 can utilize the same node 110 (i.e., the same radio access technology).

Such mobile devices 120, or handsets, are also called global phones and are essentially two phones in one device. For this particular example of a dual mode CDMA2000 and GSM phone, there are two possibilities, either two cards (R-UIM and SIM) or one card (SIM-only) 126 where the R-UIM information 128 is stored in the mobile equipment (i.e., handset shell). Thus, a computing platform 130 of the mobile device 120 can store multiple subscription data 122, 124. Subscription data 122, 124 can refer to wireless operator given data in a smart card, e.g. SIM card/USIM Card/CSIM card, etc.

The mobile device 120 may use a shared radio, depicted as a first transceiver 132, to access all cellular networks 106, 108. As an example, a dual subscription device could either use a single radio to access two networks, which is called dual standby radio device. Alternatively, the mobile device 120 can use dedicated radios, as depicted in phantom as a second transceiver 134, to access each cellular network 106, 108 (e.g., nodes 110, 112). For example, the mobile device 120 can use two radios to access two networks 106, 108, which could be called a dual radio device.

Alternatively or in addition, the first and second radio access technologies are respectively selected from a group consisting of a Wireless Wide Area Network (WWAN) and a Wireless Local Access Network (WLAN).

Alternatively or in addition, the first and second radio access technologies can be the same. Thus, a dual radio device can be provisioned with two subscriptions to the same RAT, such as a mobile device with different subscription plans to happen to be usable via the same access node.

A utility 136 executed by the computing platform 130 is provided for accessing WWAN communication with multiple subscriptions for an emergency call. In particular, the utility 136 optimizes scanning for at least limited service to increase battery service life or increase availability of a single radio.

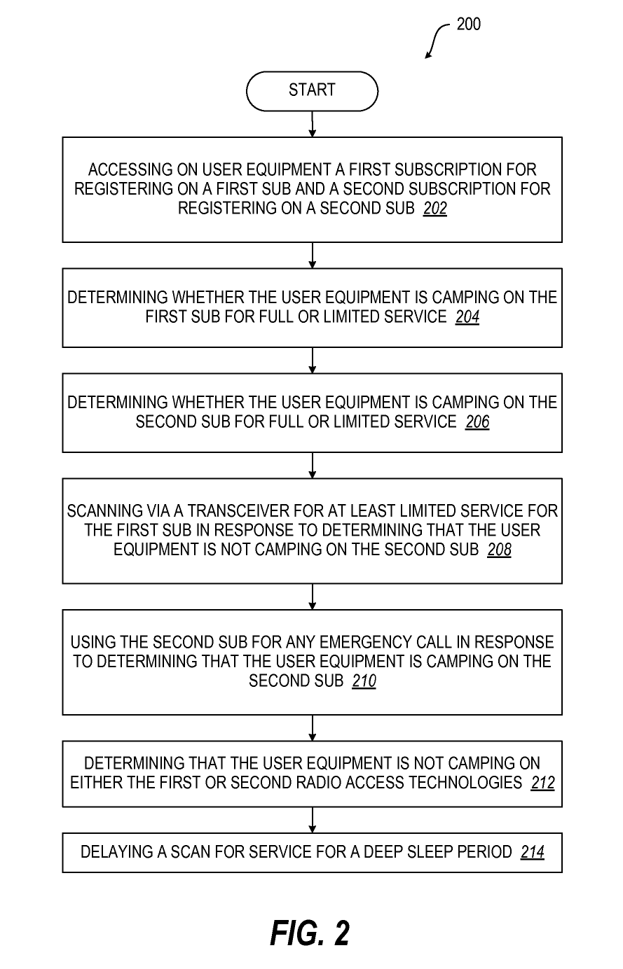

In FIG. 2, a methodology 200 is depicted for accessing wireless wide area network communication with multiple subscriptions for an emergency call. User equipment accesses a first subscription for registering on a first radio access technology and a second subscription for registering on a second radio access technology (block 202). The user equipment determines whether the user equipment is camping on the first radio access technology for full or limited service (block 204). The user equipment determines whether the user equipment is camping on the second radio access technology for full or limited service (block 206). The user equipment scans via a first transceiver for at least limited service for the first radio access technology in response to determining that the user equipment is not camping on the second radio access technology (block 208). The user equipment uses the second radio access technology for any emergency call in response to determining that the user equipment is camping on the second radio access technology (block 210). Subsequently, the user equipment determines that the user equipment is not camping on either the first or second radio access technologies (block 212). The user equipment delays a scan for service for a deep sleep period (block 214).

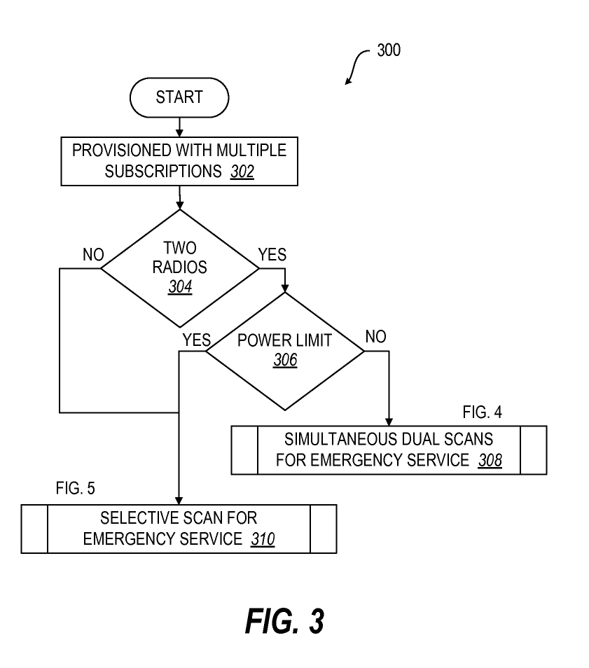

In an exemplary aspect in FIG. 3, a methodology 300 is provided that adapts scanning for multiple subscriptions for emergency call connectivity to transceiver and power constraints of the mobile device or user equipment. The mobile device is provisioned with multiple subscriptions (block 302). Each subscription can entitle the device to full or limited service on a respective radio access technology (e.g., GSM, CDMA, etc.). In a further aspect, a second or third subscription can be for a WLAN technology.

A determination is made as to whether the mobile device has multiple radios (e.g., at least two) (block 304). If so, then a constraint of having to tune away a shared radio is not a factor. Thus, a further determination is made as to whether a power limit exists (block 306). If no limit, then simultaneous dual scans for emergency service can be enabled (block 308). For example, a mobile device can be supported by a vehicle with essentially unlimited power.

However, if only a single radio was determined in block 304 or if a power limit is determined to exist in block 306, then the mobile device can employ selective scans for emergency service (block 308).

It should be appreciated with the benefit of the present disclosure that these determinations for device constraints of dedicated radios and power limits can be dictated in advance by a design of the device. Alternatively, these determinations can be dynamic. For example, a secondary radio can have inferior performance that in some instances reduces the device effectively to a single radio. For another example, the amount of stored battery charge can initially be deemed non-limiting and subsequently deemed critical to avoid device shutdown.

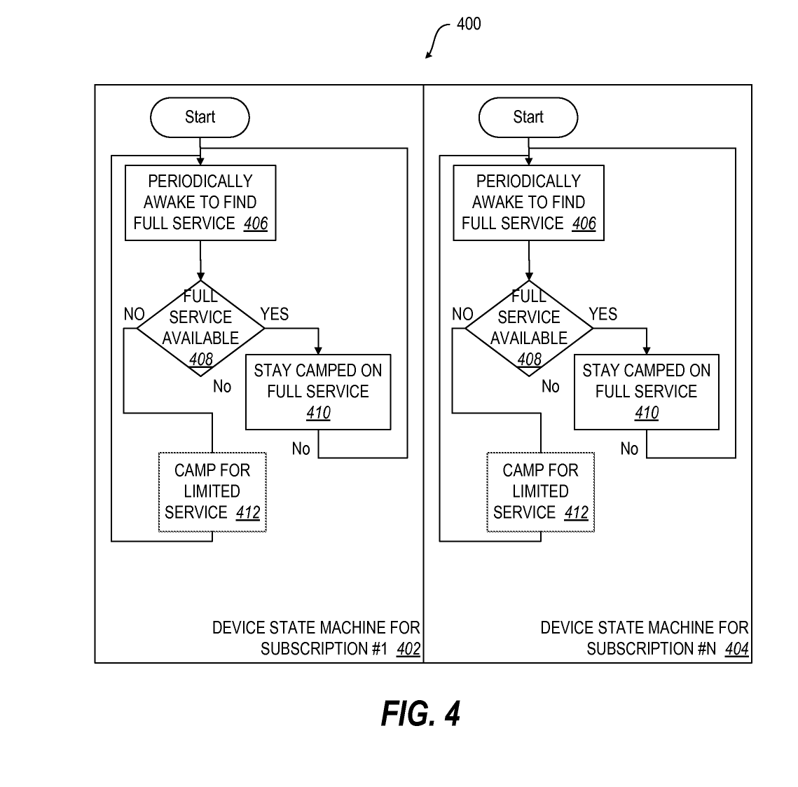

In FIG. 4, an illustrative state machine 400 for implementing block 308 (FIG. 3) is depicted for two independently scanning subscriptions at 402 and 404. Periodically, each state machine awakes to find full service (block 406). A determination is made as to whether full service is available (block 408). If so, the state machine stays camped on the full service (block 410). Processing returns to block 406 to update measurements for service. If no full service available in block 408, which includes a subscription being limited to emergency calls, then the state machine camps on any available limited service (block 412). Processing returns to block 406 to update measurements for service. In one aspect, especially in a power constrained implementation, the device can go into a deep sleep when unable to find limited service (not shown).

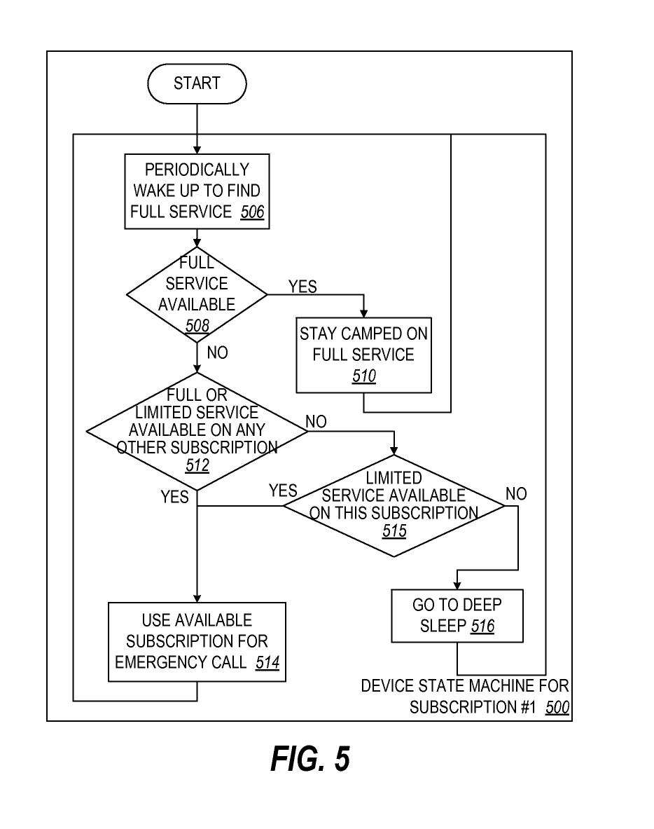

In FIG. 5, an illustrative state machine 500 for implementing block 310 (FIG. 3) is depicted for an enhanced scanning of a subscription. For clarity, only one state machine is depicted. In an exemplary aspect, a state machine for each subscription ise enhanced to start a limited service acquisition for a subscription only if none of the other active subscriptions have any service. To that end, periodically, each state machine awakes to find full service (block 506). A determination is made as to whether full service is available (block 508). If so, the state machine stays camped on the full service (block 510). Processing returns to block 506 to update measurements for service. If no full service is available in block 508, which includes a subscription being limited to emergency calls, then a determination is made as to whether full or limited service is available on any other subscription (block 512). If so, then the mobile device camps on any available service for another subscription (block 514). Processing returns to block 506 to update measurements for service. If no service is found for another subscription in block 512, then a further determination is made as to whether limited service is available on the primary subscription (block 515). If, so processing proceeds to block 514 to use this discovered limited service. Otherwise, the device can go into a deep sleep mode to preserve battery power (block 516).

It should be appreciated with the benefit of the present disclosure that the device looks for limited service on a subscription only if none of the other active subscriptions have any service. Such selective scanning for multiple subscriptions can achieve a reduction in page misses for in-service subscription for multiple subscription single radio devices. Increased usability can be achieved for multiple subscription single radio devices. In addition, power consumption can be reduced.

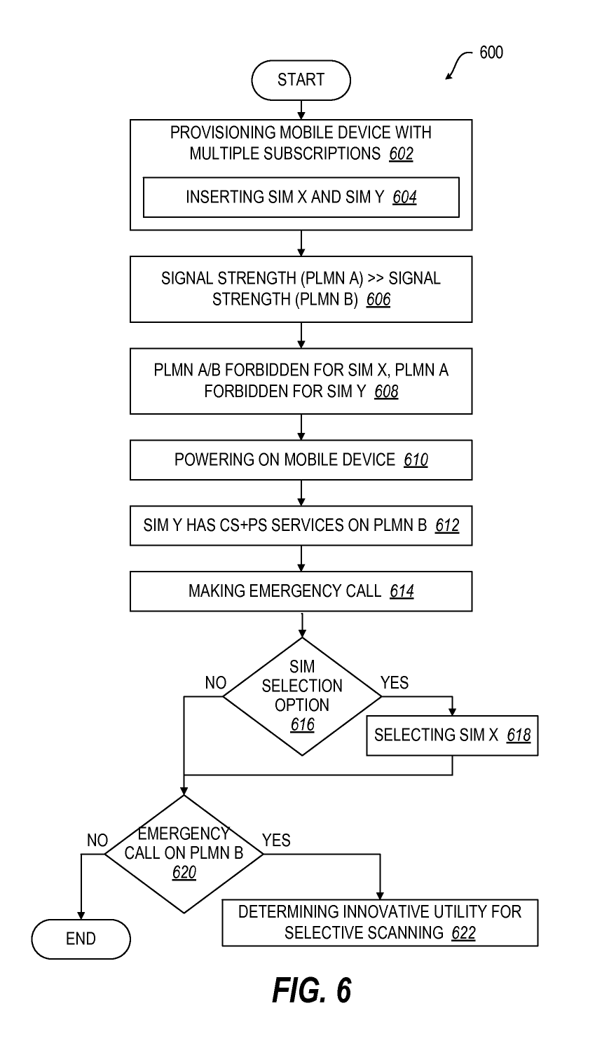

In FIG. 6, an illustrative methodology 600 can validate performance of the innovation. In block 602, as a precondition, a mobile device is provisioned with multiple subscriptions. For example, two SIM cards X and Y are inserted into the mobile device (block 604). Two Private Land Mobile Networks (PLMNs) A and B are made available to the mobile device such that signal strength of PLMN A is much better than that of PLMN B (block 606). Both PLMNs are forbidden for SIM X and PLMN A is forbidden for SIM Y (block 608).

With the device prepared, the test is performed by powering on the device (block 610). The above-described preconditions ensure that SIM Y has CS+PS service on PLMN B (block 612). An emergency call is made (block 614). A determination is made as to whether the mobile device gives an option of selecting SIM while making the emergency call (block 616). If so, SIM X is selected (block 618).

A determination is made whether the emergency call is going out on PLMN B (block 620). If so, this indicates execution of the innovative utility for selective scanning on multiple subscriptions (block 622).

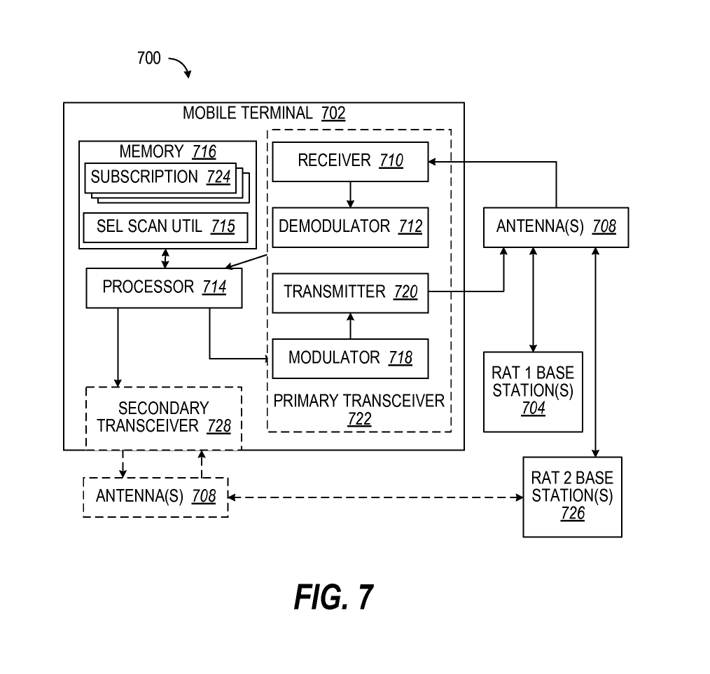

FIG. 7 is a block diagram of another system 700 that can be utilized to implement various aspects of the functionality described herein. In one example, system 700 includes a mobile terminal 702. As illustrated, mobile terminal 702 can receive signal(s) from one or more base stations 704 and transmit to the one or more base stations 704 via one or more antennas 708. Additionally, mobile terminal 702 can comprise a receiver 710 that receives information from antenna(s) 708. In one example, receiver 710 can be operatively associated with a demodulator 712 that demodulates received information. Demodulated symbols can then be analyzed by a processor 714. Processor 714 can be coupled to memory 716, which can store data and/or program codes related to mobile terminal 702. Additionally, mobile terminal 702 can employ processor 714 to perform methodologies described herein, depicted as selective scan utility 715. Mobile terminal 702 can also include a modulator 718 that can multiplex a signal for transmission by a transmitter 720 through antenna(s) 708. The receiver 710, demodulator 712, transmitter 720, and modulator 718 form a first or primary transceiver 722, which can be shared by multiple subscriptions 724, depicted as stored in memory 716. In particular, time division duplexing can be used to tune to base station(s) or nodes 704 that use a first RAT (e.g., GSM) and to base station(s) or nodes 726 that use a second RAT (e.g., CDMA).

Alternatively, a second or secondary transceiver 728 that utilizes antennas 708 can simultaneously access base station(s) or nodes 726 while the first transceiver 722 access the base station(s) or nodes 704.

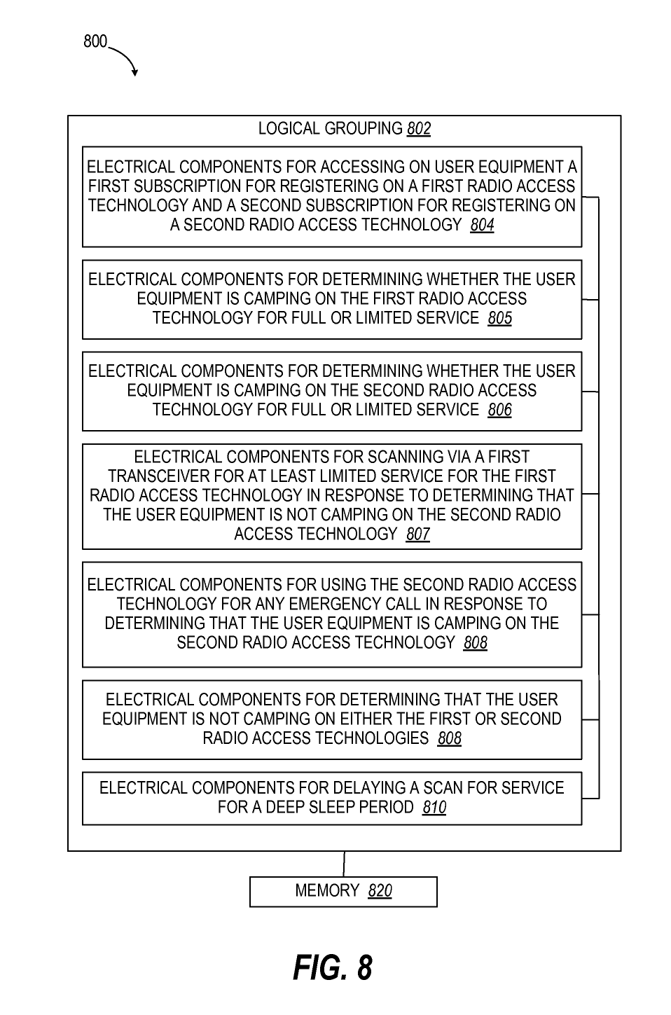

With reference to FIG. 8, illustrated is a system 800 for accessing wireless wide area network communication with multiple subscriptions for an emergency call. For example, system 800 can reside at least partially within user equipment (UE). It is to be appreciated that system 800 is represented as including functional blocks, which can be functional blocks that represent functions implemented by a computing platform, processor, software, or combination thereof (e.g., firmware). System 800 includes a logical grouping 802 of electrical components that can act in conjunction. For instance, logical grouping 802 can include an electrical component 804 for accessing on user equipment a first subscription for registering on a first radio access technology and a second subscription for registering on a second radio access technology. Moreover, logical grouping 802 can include an electrical component 805 for determining whether the user equipment is camping on the first radio access technology for full or limited service. Further, logical grouping 802 can include an electrical component 806 for determining whether the user equipment is camping on the second radio access technology for full or limited service. Logical grouping 802 can include an electrical component 807 for scanning via a first transceiver for at least limited service for the first radio access technology in response to determining that the user equipment is not camping on the second radio access technology. In addition, logical grouping 802 can include an electrical component 808 for using the second radio access technology for any emergency call in response to determining that the user equipment is camping on the second radio access technology. As another example, logical grouping 802 can include an electrical component 809 for determining that the user equipment is not camping on either the first or second radio access technologies. Also, logical grouping 802 can include an electrical component 810 for delaying a scan for service for a deep sleep period. Additionally, system 800 can include a memory 820 that retains instructions for executing functions associated with electrical components 804-810. While shown as being external to memory 820, it is to be understood that one or more of electrical components 804-810 can exist within memory 820.

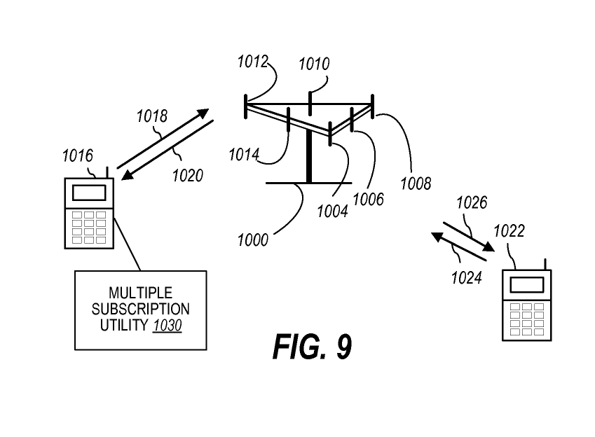

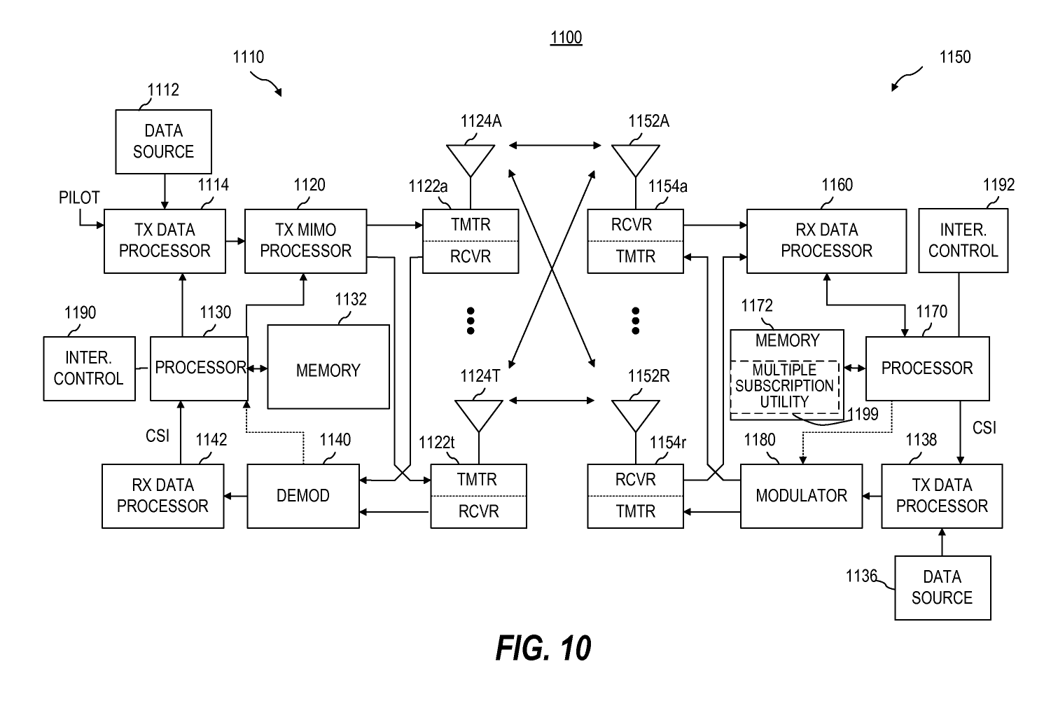

Referring to FIG. 9, a multiple access wireless communication system according to one aspect is illustrated. An access point (AP) 1000 includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal (AT) 1016 is in communication with antennas 1012 and 1014, where antennas 1012 and 1014 transmit information to access terminal 1016 over forward link 1020 and receive information from access terminal 1016 over reverse link 1018. Access terminal 1022 is in communication with antennas 1006 and 1008, where antennas 1006 and 1008 transmit information to access terminal 1022 over forward link 1026 and receive information from access terminal 1022 over reverse link 1024. In a FDD system, communication links 1018, 1020, 1024 and 1026 may use different frequencies for communication. For example, forward link 1020 may use a different frequency then that used by reverse link 1018.

Each group of antennas and/or the area in which they are designed to communicate is often referred to as a sector of the access point. In the aspect, antenna groups each are designed to communicate to access terminals in a sector, of the areas covered by access point 1000.

In communication over forward links 1020 and 1026, the transmitting antennas of access point 1000 utilize beamforming in order to improve the signal-to-noise ratio of forward links for the different access terminals 1016 and 1022. Also, an access point using beamforming to transmit to access terminals scattered randomly through its coverage causes less interference to access terminals in neighboring cells than an access point transmitting through a single antenna to all of its access terminals.

AT 1016 incorporates a selective scanning utility 1030 for emergency call access using one of a plurality of subscriptions.

An access point may be a fixed station used for communicating with the terminals and may also be referred to as an access point, a Node B, or some other terminology. An access terminal may also be called user equipment (UE), a wireless communication device, terminal, or some other terminology.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

The teachings herein may be incorporated into a node (e.g., a device) employing various components for communicating with at least one other node. FIG. 10 depicts several sample components that may be employed to facilitate communication between nodes. Specifically, FIG. 10 illustrates a wireless device 1110 (e.g., an access point) and a wireless device 1150 (e.g., an access terminal) of a MIMO system 1100. At the device 1110, traffic data for a number of data streams is provided from a data source 1112 to a transmit (“TX”) data processor 1114.

In some aspects, each data stream is transmitted over a respective transmit antenna. The TX data processor 1114 formats, codes, and interleaves the traffic data for each data stream based on a particular coding scheme selected for that data stream to provide coded data.

The coded data for each data stream may be multiplexed with pilot data using orthogonal frequency division multiple access (OFDMA) techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1130. A data memory 1132 may store program code, data, and other information used by the processor 1130 or other components of the device 1110.

The modulation symbols for all data streams are then provided to a TX MIMO processor 1120, which may further process the modulation symbols (e.g., for OFDM). The TX MIMO processor 1120 then provides N_{T} modulation symbol streams to N_{T} transceivers (“XCVR”) 1122a through 1122t. In some aspects, the TX MIMO processor 1120 applies beam-forming weights to the symbols of the data streams and to the antenna from which the symbol is being transmitted.

Each transceiver 1122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1122a through 1122t are then transmitted from N_{T} antennas 1124a through 1124t, respectively.

At the device 1150, the transmitted modulated signals are received by N_{R} antennas 1152a through 1152r and the received signal from each antenna 1152 is provided to a respective transceiver (“XCVR”) 1154a through 1154r. Each transceiver 1154 conditions (e.g., filters, amplifies, and downconverts) a respective received signal, digitizes the conditioned signal to provide samples, and further processes the samples to provide a corresponding “received” symbol stream.

A receive (“RX”) data processor 1160 then receives and processes the N_{R} received symbol streams from N_{R} transceivers 1154 based on a particular receiver processing technique to provide N_{T} “detected” symbol streams. The RX data processor 1160 then demodulates, deinterleaves, and decodes each detected symbol stream to recover the traffic data for the data stream. The processing by the RX data processor 1160 is complementary to that performed by the TX MIMO processor 1120 and the TX data processor 1114 at the device 1110.

A processor 1170 periodically determines which pre-coding matrix to use (discussed below). The processor 1170 formulates a reverse link message comprising a matrix index portion and a rank value portion. A data memory 1172 may store program code, data, and other information used by the processor 1170 or other components of the device 1150.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by the transceivers 1154a through 1154r, and transmitted back to the device 1110.

At the device 1110, the modulated signals from the device 1150 are received by the antennas 1124, conditioned by the transceivers 1122, demodulated by a demodulator (“DEMOD”) 1140, and processed by a RX data processor 1142 to extract the reverse link message transmitted by the device 1150. The processor 1130 then determines which pre-coding matrix to use for determining the beam-forming weights then processes the extracted message.

FIG. 10 also illustrates that the communication components may include one or more components that perform interference control operations as taught herein. For example, an interference (“INTER.”) control component 1190 may cooperate with the processor 1130 and/or other components of the device 1110 to send/receive signals to/from another device (e.g., device 1150) as taught herein. Similarly, an interference control component 1192 may cooperate with the processor 1170 and/or other components of the device 1150 to send/receive signals to/from another device (e.g., device 1110). It should be appreciated that for each device 1110 and 1150 the functionality of two or more of the described components may be provided by a single component. For example, a single processing component may provide the functionality of the interference control component 1190 and the processor 1130 and a single processing component may provide the functionality of the interference control component 1192 and the processor 1170.

The memory 1172 of the device 1150 incorporates a multiple subscription utility 1199 for performing methodologies described herein.

It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatuses described herein are described in the context of providing dynamic queries and recommendations in a mobile communication environment. One skilled in the art should appreciate that similar techniques could apply to other communication and non-communication environments as well.

As used in this disclosure, the term “content” and “objects” are used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in hardware, in a software module executed by a processor, or in a combination of the two. Additionally, in some aspects, the operations or actions of a method or algorithm can reside as at least one or any combination or set of codes or instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction, or data.

Furthermore, various aspects are described herein in connection with an apparatus that is a mobile device. A mobile device can also be called a system, a subscriber unit, a subscriber station, mobile station, mobile, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device. Further, aspects can be employed by an apparatus that is a fixed or portable device communicating at least in part by an air link.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events or data. Such inference results in the construction of new events or actions from a set of observed events or stored event data, whether or not the events are correlated in close temporal proximity, and whether the events and data come from one or several event and data sources.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method for accessing wireless wide area network communication with multiple subscriptions for an emergency call, comprising:
accessing on user equipment a first subscription for registering on a first radio access technology and a second subscription for registering on a second radio access technology;
determining whether the user equipment is camping on the first radio access technology for full or limited service;
determining whether the user equipment is camping on the second radio access technology for full or limited service;
scanning via a first transceiver for at least limited service for the first radio access technology in response to determining that the user equipment is not camping on the second radio access technology; and
using the second radio access technology for any emergency call in response to determining that the user equipment is camping on the second radio access technology.

2. The method of claim 1, wherein the user equipment is provisioned with two radio transceivers for simultaneous subscription scanning.

3. The method of claim 1, wherein the user equipment is provisioned with one radio transceiver for sequential subscription scanning.

4. The method of claim 1, further comprising:
determining that the user equipment is not camping on either the first or second radio access technologies; and
delaying a scan for service for a deep sleep period.

5. The method of claim 1, wherein the first and second radio access technologies are respectively selected from a group consisting of Global System for Mobile Communications (GSM) and Code Division Multiple Access (CDMA) technologies.

6. The method of claim 1, wherein the first and second radio access technologies are respectively selected from a group consisting of a Wireless Wide Area Network (WWAN) and a Wireless Local Access Network (WLAN).

7. The method of claim 1, wherein the first and second radio access technologies are the same.

8. At least one processor for accessing wireless wide area network communication with multiple subscriptions for an emergency call, comprising:
a first module for accessing on user equipment a first subscription for registering on a first radio access technology and a second subscription for registering on a second radio access technology;
a second module for determining whether the user equipment is camping on the first radio access technology for full or limited service;
a third module for determining whether the user equipment is camping on the second radio access technology for full or limited service;
a fourth module for scanning via a first transceiver for at least limited service for the first radio access technology in response to determining that the user equipment is not camping on the second radio access technology; and
a fifth module for using the second radio access technology for any emergency call in response to determining that the user equipment is camping on the second radio access technology.

9. The at least one processor of claim 8, wherein the user equipment is provisioned with two radio transceivers for simultaneous subscription scanning.

10. The at least one processor of claim 8, wherein the user equipment is provisioned with one radio transceiver for sequential subscription scanning.

11. The at least one processor of claim 8, further comprising:
determining that the user equipment is not camping on either the first or second radio access technologies; and
delaying a scan for service for a deep sleep period.

12. The at least one processor of claim 8, wherein the first and second radio access technologies are the same.

13. The at least one processor of claim 9, wherein the first and second radio access technologies are respectively selected from a group consisting of Global System for Mobile Communications (GSM) and Code Division Multiple Access (CDMA) technologies.

14. The at least one processor of claim 9, wherein the first and second radio access technologies are respectively selected from a group consisting of a Wireless Wide Area Network (WWAN) and a Wireless Local Access Network (WLAN).

15. A computer program product for accessing wireless wide area network communication with multiple subscriptions for an emergency call, comprising:
a non-transitory computer-readable medium storing sets of code comprising:
a first set of code for causing a computer to access on user equipment a first subscription for registering on a first radio access technology and a second subscription for registering on a second radio access technology;
a second set of code for causing the computer to determine whether the user equipment is camping on the first radio access technology for full or limited service;
a third set of code for causing the computer to determine whether the user equipment is camping on the second radio access technology for full or limited service;
a fourth set of code for causing the computer to scan via a first transceiver for at least limited service for the first radio access technology in response to determining that the user equipment is not camping on the second radio access technology; and
a fifth set of code for causing the computer to use the second radio access technology for any emergency call in response to determining that the user equipment is camping on the second radio access technology.

16. The computer program product of claim 15, wherein the user equipment is provisioned with two radio transceivers for simultaneous subscription scanning.

17. The computer program product of claim 15, wherein the user equipment is provisioned with one radio transceiver for sequential subscription scanning.

18. The computer program product of claim 15, further comprising:
a set of code for causing the computer to determine that the user equipment is not camping on either the first or second radio access technologies; and
a set of code for causing the computer to delay a scan for service for a deep sleep period.

19. The computer program product of claim 15, wherein the first and second radio access technologies are respectively selected from a group consisting of Global System for Mobile Communications (GSM) and Code Division Multiple Access (CDMA) technologies.

20. The computer program product of claim 15, wherein the first and second radio access technologies are respectively selected from a group consisting of a Wireless Wide Area Network (WWAN) and a Wireless Local Access Network (WLAN).

21. The computer program product of claim 15, wherein the first and second radio access technologies are the same.

22. An apparatus for accessing wireless wide area network communication with multiple subscriptions for an emergency call, comprising:
means for accessing on user equipment a first subscription for registering on a first radio access technology and a second subscription for registering on a second radio access technology;
means for determining whether the user equipment is camping on the first radio access technology for full or limited service;
means for determining whether the user equipment is camping on the second radio access technology for full or limited service;
means for scanning via a first transceiver for at least limited service for the first radio access technology in response to determining that the user equipment is not camping on the second radio access technology; and
means for using the second radio access technology for any emergency call in response to determining that the user equipment is camping on the second radio access technology.

23. The apparatus of claim 22, wherein the user equipment is provisioned with two radio transceivers for simultaneous subscription scanning.

24. The apparatus of claim 22, wherein the user equipment is provisioned with one radio transceiver for sequential subscription scanning.

25. The apparatus of claim 22, further comprising:
means for determining that the user equipment is not camping on either the first or second radio access technologies; and
means for delaying a scan for service for a deep sleep period.

26. The apparatus of claim 22, wherein the first and second radio access technologies are respectively selected from a group consisting of Global System for Mobile Communications (GSM) and Code Division Multiple Access (CDMA) technologies.

27. The apparatus of claim 22, wherein the first and second radio access technologies are respectively selected from a group consisting of a Wireless Wide Area Network (WWAN) and a Wireless Local Access Network (WLAN).

28. The apparatus of claim 22, wherein the first and second radio access technologies are the same.

29. An apparatus for accessing wireless wide area network communication with multiple subscriptions for an emergency call, comprising:
a computing platform for accessing on user equipment a first subscription for registering on a first radio access technology and a second subscription for registering on a second radio access technology;
the computing platform further for determining whether the user equipment is camping on the first radio access technology for full or limited service;
the computing platform further for determining whether the user equipment is camping on the second radio access technology for full or limited service;
a first transceiver for scanning for at least limited service for the first radio access technology in response to the computing platform determining that the user equipment is not camping on the second radio access technology; and
the computing platform further for using the second radio access technology for any emergency call in response to determining that the user equipment is camping on the second radio access technology.

30. The apparatus of claim 29, further comprising a second transceiver for simultaneous subscription scanning.

31. The apparatus of claim 29, wherein the first transceiver is further for sequential subscription scanning.

32. The apparatus of claim 29, wherein the computing platform is further for determining that the user equipment is not camping on either the first or second radio access technologies and for delaying a scan for service for a deep sleep period.

33. The apparatus of claim 29, wherein the first and second radio access technologies are respectively selected from a group consisting of Global System for Mobile Communications (GSM) and Code Division Multiple Access (CDMA) technologies.

34. The apparatus of claim 29, wherein the first and second radio access technologies are respectively selected from a group consisting of a Wireless Wide Area Network (WWAN) and a Wireless Local Access Network (WLAN).

35. The apparatus of claim 29, wherein the first and second radio access technologies are the same.
